(19) United States
(12) Patent Application Publication
(10) Pub. No.: US 2008/0314061 A1
(43) Pub. Date: Dec. 25, 2008

(54) AIR CONDITIONING SYSTEM

(75) Inventors: Kouji NAGAMI, Osaka (JP); Masamichi Miyazaki, Osaka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KOMATSU LTD., Tokyo (JP)

(21) Appl. No.: 12/142,867

(22) Filed: Jun. 20, 2008

(30) Foreign Application Priority Data
Jun. 21, 2007 (JP) 2007-163593

(51) Int. Cl. B60H 1/32; F25B 29/00; F25D 17/06; B60S 1/54; F24F 3/02

(52) U.S. Cl. 62/244; 62/159; 62/426; 454/121; 454/238

(57) ABSTRACT

An air conditioning system includes a controller for controlling the feed rate of air from a blower such that the inside of the operator's cab is at higher pressure than outside pressure when a pressurization mode for pressurizing the inside of the operator's cab is selected, a branch duct opening/closing damper device is provided for distributing the air from the blower to an air outlet directed to an operator and an air outlet undirected to the operator (i.e., a defroster air outlet). Further, the controller controls the branch duct opening/closing damper device such that the air is ejected from the air outlet directed to the operator in such a volume that makes the operator have comfortable cool or warm feeling whereas the remaining volume of air is ejected from the defroster air outlet, when the difference between the inside air temperature of the operator's cab and a preset temperature becomes small.

### TECHNICAL FIELD

The present invention relates to an air conditioning system capable of maintaining the inside of an operator's cab at higher pressure than outside pressure.

### BACKGROUND ART

Work vehicles such as hydraulic excavators and bulldozers are often used in dust-laden work environments. The work vehicles of this type are therefore required to have the function of preventing the penetration of dust and so on into the operator's cab through the gaps around the door or window panes. One known means that implements such a function makes use of the air conditioning system installed in the work vehicle. Specifically, air introduced from an outside air inlet is sent to the operator's cab to pressurize the inside thereof, thereby maintaining the inside of the operator's cab at higher pressure than outside pressure. This prevents dust and so on from penetrating into the operator's cab through the gaps around the door or window panes.

In the conventional air conditioning systems of this type, when executing A/C (Air Conditioning) automatic control for automatically controlling the feed rate of air and so on, the feed rate is controlled according to the difference between an inside air temperature of the operator's cab and a preset temperature. If the difference between an inside air temperature of the operator's cab and a preset temperature becomes small, the feed rate of air sent to the operator's cab decreases, so that the inside of the operator's cab cannot be sufficiently pressurized. As a result, the penetration of dust and so on into the operator's cab cannot be reliably prevented.

One previous attempt to overcome the above shortcoming is the air conditioning control system disclosed in JP-A-11-129726 (1999). According to this air conditioning control system, the pressurization mode for pressurizing the inside of the operator's cab is selected by turning the pressurization switch ON and in this mode, a specified volume of air required to maintain the inside of the operator's cab at higher pressure than outside pressure is continuously fed to the operator's cab to pressurize the inside thereof even if the difference between the inside air temperature of the operator's cab and a preset temperature becomes small. Therefore, the penetration of dust and so on into the operator's cab can be prevented without fail.

However, the air conditioning control system of JP-A-11-129726 (1999) has revealed the problem that if all the air ejected from the air outlets in the operator's cab directly hits against the operator when the difference between the inside air temperature of the operator's cab and a preset temperature is small, the comfortable air-conditioned environment will be spoiled and therefore the operator will have feeling of discomfort.

The invention is directed to overcoming the above problem and a primary object of the invention is therefore to provide an air conditioning system capable of constantly maintaining the inside of the operator's cab at higher pressure than outside pressure so that the penetration of dust and so on into the operator's cab can be unfailingly prevented without spoiling the comfortable air-conditioned environment.

### SUMMARY OF THE INVENTION

The above object can be achieved by an air conditioning system according to the invention which comprises: a blower for sending air introduced through an outside air inlet; temperature controlling means for controlling the temperature of the air sent from the blower based on a preset temperature; operator's cab air outlets arranged to eject the air temperature-controlled by the temperature controlling means into an operator's cab; air feed rate controlling means for controlling an air feed rate of the blower so as to make inside pressure of the operator's cab higher than outside pressure,

wherein the operator's cab air outlets include an air outlet directed to an operator to eject the air toward the operator in the operator's cab and an air outlet undirected to the operator to eject the air such that the air does not directly hit against the operator,

the air conditioning system further comprising: air distributing means for distributing the air sent from the blower to the air outlet directed to the operator and the air outlet undirected to the operator; and air distribution controlling means for controlling the distribution by the air distributing means such that the volume of air distributed to the air outlet undirected to the operator is larger than the volume of air distributed to the air outlet directed to the operator, when the difference between the inside air temperature of the operator's cab and the preset temperature is small.

According to the invention, the air feed rate of the blower is controlled so as to make the inside pressure of the operator's cab higher than outside pressure, which enables it to pressurize the inside of the operator's cab with a specified volume of air required to maintain the inside of the operator's cab at higher pressure than outside pressure. By constantly maintaining the inside of the operator's cab at higher pressure than outside pressure, dust and the like can be prevented from penetrating into the operator's cab without fail. In addition, the air sent from the blower is distributed to the air outlet directed to the operator and the air outlet undirected to the operator by the air distributing means and the volumes of air distributed to these air outlets are controlled by the air distribution controlling means based on the difference between the inside air temperature of the operator's cab and a preset temperature. Therefore, the volume of air required to maintain the inside of the operator's cab at higher pressure than outside pressure can be distributed to the air outlet directed to the operator and the air outlet undirected to the operator, and when the difference between the inside air temperature of the operator's cab and the preset temperature becomes small, the volume of air that makes the operator have comfortable cool or warm feeling is ejected from the air outlet directed to the operator, whereas the remaining volume of air is ejected from the air outlet undirected to the operator. As a result, the penetration of dust and so on from the outside of the operator's cab can be prevented without spoiling the comfortable air-conditioned environment.

### BRIEF DESCRIPTION OF DRAWINGS

FIG. 1 is an overall external perspective view of an air conditioning system according to a first embodiment of the invention.

FIG. 2 is a schematic system structural diagram of the air conditioning system of the first embodiment.

FIG. 3 is a flow chart showing the contents of the processing of a controller.

FIG. 4(a) is an air feed rate control map for a blower in PRESSURIZATION mode; FIG. 4(b) is an air volume control map for an air outlet directed to the operator; and FIG. 4(c) is an air volume control map for an air outlet undirected to the operator.

FIG. 5 is an air outlet mode switching control map.

FIG. 6 is an air feed rate control map for the blower when normal A/C automatic control is executed.

FIG. 7 is an overall external perspective view of an air conditioning system according to a second embodiment of the invention.

FIG. 8 is a schematic system structural diagram of the air conditioning system of the second embodiment.

### DETAILED DESCRIPTION OF THE INVENTION

Referring now to the accompanying drawings, the air conditioning system of the invention will be described according to preferred embodiments of the invention. It should be noted that the following embodiments are associated with cases where the invention is applied to an air conditioning system installed in a hydraulic excavator.

### First Embodiment

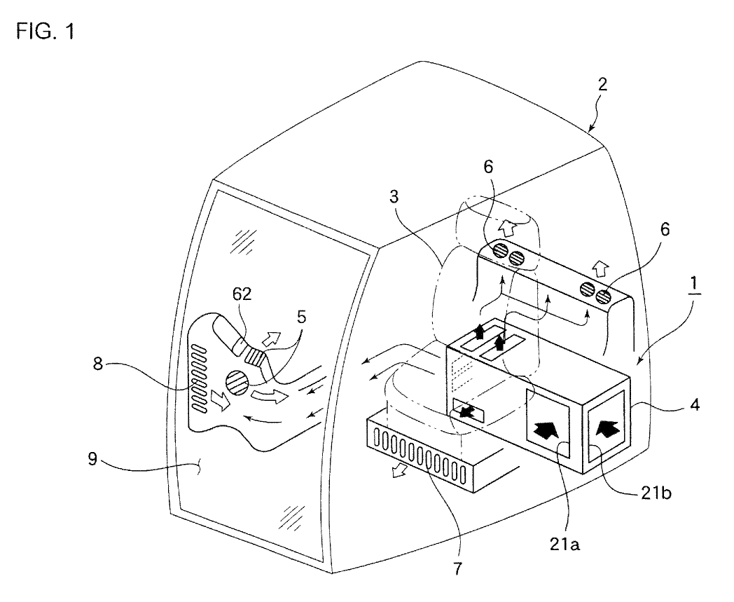

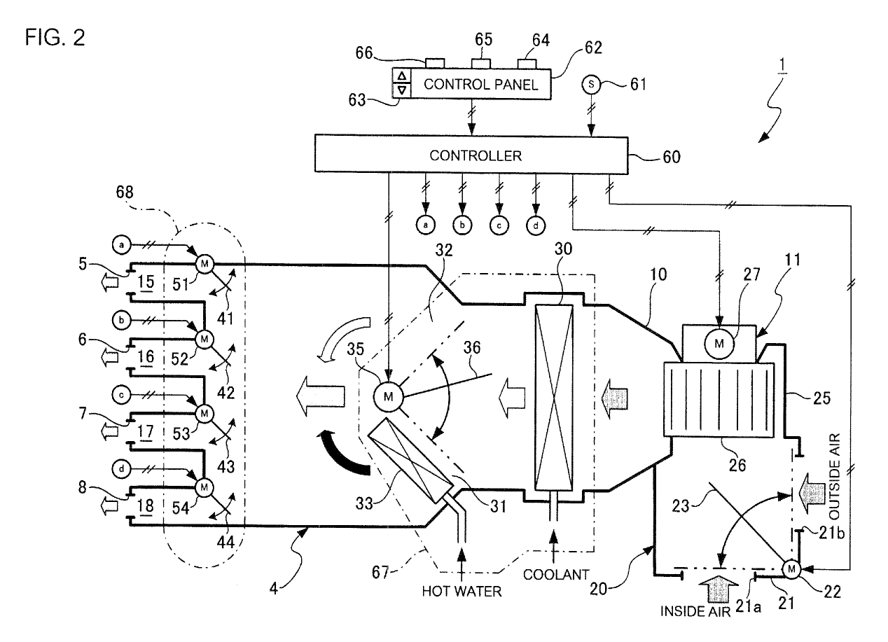

FIG. 1 is an overall external perspective view of an air conditioning system according to a first embodiment of the invention. FIG. 2 is a schematic system structural diagram of the air conditioning system of the first embodiment.

As illustrated in FIG. 1, the air conditioning system 1 of this embodiment has: a system body 4 placed behind an operator's seat 3 provided in an operator's cab 2; a face-level air outlet 5 arranged to direct air to the face or chest of the operator sitting on the operator's seat 3; a rear air outlet 6 arranged to direct air to the occiput and upper back of the operator sitting on the operator's seat 3; a foot-level air outlet 7 arranged to direct air to the feet of the operator sitting on the operator's seat 3; and a defroster air outlet 8 arranged to direct air to a front window pane 9 of the operator's cab 2. The face-level air outlet 5, rear air outlet 6, foot-level air outlet 7, and defroster air outlet 8 are openings through which air is blown out to the inside of the operator's cab 2. Of these air outlets, the face-level air outlet 5, rear air outlet 6, foot-level air outlet 7 are designed to eject a stream of air in a direction toward the operator in the operator's cab 2 whereas the defroster air outlet 8 is designed to eject a stream of air in such a direction that the air does not directly hit against the operator in the operator's cab 2.

As illustrated in FIG. 2, the system body 4 has a main duct 10 that serves as a main passage for air. Attached to the upstream opening part of the main duct 10 is a blower 11. Connected to the downstream opening part of the main duct 10 are a first branch duct 15 for guiding air to the face-level air outlet 5; a second branch duct 16 for guiding air to the rear air outlet 6; a third branch duct 17 for guiding air to the foot-level air outlet 7; and a fourth branch duct 18 for guiding air to the defroster air outlet 8.

On the air suction opening side of the blower 11, an inside/outside air switching means 20 is provided. The inside/outside air switching means 20 includes an inside/outside air switching box 21 provided with an inside air inlet 21a through which air within the operator's cab 2 comes in and an outside air inlet 21b through which air outside the operator's cab 2 comes in.

Provided within the inside/outside air switching box 21 is an inside/outside air switching damper 23 that is rotatively driven by a damper driving motor 22. The rotation of the damper driving motor 22 is controlled, thereby executing switching between an inside air inlet closed state where the inside/outside air switching damper 23 closes the inside air inlet 21a and an outside air inlet closed state where the inside/outside air switching damper 23 closes the outside air inlet 21b. In the inside air inlet closed state, air outside the operator's cab 2 is introduced into the inside/outside air switching box 21 through the outside air inlet 21b. On the other hand, in the outside air inlet closed state, air inside the operator's cab 2 is introduced into the inside/outside air switching box 21 through the inside air inlet 21a.

The blower 11 is composed of a fan case 25, a blower fan 26 housed in the fan case 25, and a fan driving motor 27 for rotatively driving the blower fan 26. When the blower fan 26 is rotatively driven by the fan driving motor 27, the air introduced into the inside/outside air switching box 21 through the inside air inlet 21a or the outside air inlet 21b is sent to the main duct 10. By controlling the rotation of the fan driving motor 27, the feed rate of air sent to the main duct 10 is controlled.

Provided within the main duct 10 is an evaporator 30 that serves as a cooling means for cooling the air from the blower 11. The evaporator 30 cools down the air passing through the evaporator 30 by heat exchange with a coolant that flows in the evaporator 30. The inner space of the main duct 10 on the downstream side of the evaporator 30 is divided into two branch passages 31, 32. One of these passages 31 has a heater core 33 as a heating means. The heater core 33 is a hot water type heater core that uses engine cooling water (hot water) as a heat source. By heat exchange with the engine cooling water circulating in the heater core 33, the air which passes through the heater core 33 is heated.

An air mix damper 36 is provided in the part where the two passages 31, 32 deviate from the main duct 10, which damper 36 is rotatively driven by a damper driving motor 35. By controlling the rotation of the damper driving motor 35, the air mix damper 36 is controlled and selectively brought to the position where the air mix damper 36 closes the passage 31 or the position where the air mix damper 36 closes the passage 32. Through the positional control of the air mix damper 36, the ratio between the air passing through the heater core 33 provided in the passage 31 and the air passing through the passage 32 is controlled. Thereby, the temperatures of the air streams ejected from the air outlets 5, 6, 7, 8 are controlled.

The upstream opening of the path of the first branch duct 15 is provided with a first branch duct opening/closing damper 41 for opening and closing the opening thereof; the upstream opening of the second branch duct 16 is provided with a second branch duct opening/closing damper 42 for opening and closing the opening thereof; the upstream opening of the third branch duct 17 is provided with a third branch duct opening/closing damper 43 for opening and closing the opening thereof; and the upstream opening of the fourth branch duct 18 is provided with a fourth branch duct opening/closing damper 44 for opening and closing the opening thereof.

Damper driving motors 51, 52, 53, 54 are provided for the branch duct opening/closing dampers 41, 42, 43, 44, respectively. The rotations of these driving motors 51, 52, 53, 54 are controlled, thereby controlling the opening degrees of the branch duct opening/closing dampers 41, 42, 43, 44. Through the control of the opening degrees of the branch duct opening/closing dampers 41, 42, 43, 44, the volume of air ejected from each of the air outlets 5, 6, 7, 8 is controlled.

As seen from Table 1, air outlet modes, i.e., VENT mode, BI-LEVEL mode, FOOT mode and DEF mode can be obtained according to the combinations of the opening/closing states of the branch duct opening/closing dampers 41, 42, 43, 44. Table 1 shows the opening/closing states of the branch duct opening/closing dampers 41, 42, 43, 44 when PRESSURIZATION mode for pressuring the inside of the operator's cab 2 is not selected.

TABLE 1

| | | BRANCH DUCT OPENING/CLOSING DAMPERS | | | |
|---|---|---|---|---|---|
| | | NUMERAL 41 | NUMERAL 42 | NUMERAL 43 | NUMERAL 44 |
| AIR | VENT MODE | OPEN | OPEN | CLOSED | CLOSED |
| OUTLET | BI-LEVEL MODE | OPEN | OPEN | OPEN | CLOSED |
| MODES | FOOT MODE | CLOSED | CLOSED | OPEN | CLOSED |
| | DEF MODE | CLOSED | CLOSED | CLOSED | OPEN |

Herein, VENT mode is an air outlet mode for directing a stream of air toward the upper half body (head and chest parts) of the operator. BI-LEVEL mode is an air outlet mode for directing a stream of air toward the upper half body (head and chest parts) and feet of the operator. FOOT mode is an air outlet mode for directing a stream of air toward the feet of the operator. DEF mode is an air outlet mode for directing a stream of air toward the front window pane 9 of the operator's cab 2. VENT mode, BI-LEVEL mode, FOOT mode are under the A/C (Air Conditioning) automatic control of the air conditioning system 1, whereas the DEF mode is under the A/C manual control in which the air feed rate and so on is manually controlled by the operator at his own discretion.

The fan driving motor 27 and the damper driving motors 22, 35, 51 to 54 are respectively connected to a controller 60 that serves as a controlling means. An inside air sensor 61 for detecting the inside air temperature of the operator's cab 2 and a control panel 62 serving as an operating means are connected to the controller 60. The control panel 62 is provided with a temperature setting switch 63 as a temperature setting means. By operating the temperature setting switch 63, the operator can set a desired temperature. Further, the control panel 62 is provided with an A/C automatic control switch 64 for executing the A/C automatic control to automatically control the feed rate of air and so on; an inside/outside air changing switch 65 for effecting switching between INSIDE AIR INTRODUCING mode and OUTSIDE AIR INTRODUCING mode of the inside/outside air switching means 20; and a pressurization switch 66 for selecting PRESSURIZATION mode to pressurize the inside of the operator's cab 2.

The controller 60 has a built-in micro computer that stores a control program and arithmetic expressions associated with the air conditioning control and the control maps. The controller 60 inputs a detection signal from the inside air sensor 61 and various operational signals issued in response to various instructions input through the control panel 62 and performs arithmetic operations on the input signals in accordance with the control program. According to the result of the arithmetic operations, the controller 60 outputs a control signal to the fan driving motor 27 and the damper driving motors 22, 35, 51 to 54 respectively to control the operations thereof.

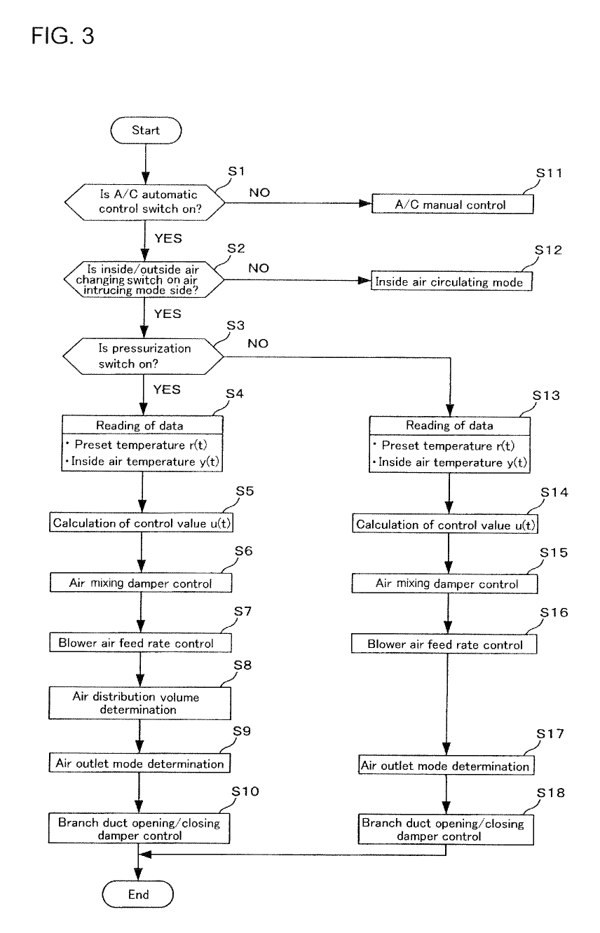

The details of the air conditioning control by the controller 60 will be described below with reference to the flow chart of FIG. 3. In FIG. 3, code “S” denotes a “step”.

(Step S1 to Step S3)

The controller 60 determines, in response to operational signals from the control panel 62, whether the A/C automatic control switch 64 has been turned ON (S1), whether the inside/outside air changing switch 65 has been operated to select OUTSIDE AIR INTRODUCING mode (S2), and whether the pressurization switch 66 has been turned ON (S3). If it is determined that the A/C automatic control switch 64 has been turned ON, the inside/outside air changing switch 65 has been operated to select OUTSIDE AIR INTRODUCING mode, and the pressurization switch 66 has been turned ON, the processes at Steps S4 to S10 will be then executed.

(Step S4 to Step S5)

A preset temperature r(t) set by the temperature setting switch 63 and an inside air temperature y(t) of the operator's cab 2 detected by the inside air sensor 61 are read in (S4).

According to the data read at Step S4 and the following equation (1), a control value u(t) is calculated (S5).

$$u ( t ) = {K}_{P} e ( t ) + {K}_{I} {\int }_{0}^{t} e ( τ ) d τ + {K}_{D} \frac{d e ( t )}{d t} \qquad ( 1 )$$

In Equation (1), e(t) denotes the difference (r(t)−y(t)) between the preset temperature r(t) and the inside air temperature y(t), Kₚ denotes a proportional gain, K_{I} denotes an integral gain, and K_{D} denotes a differential gain. As apparently seen from Equation (1), the air conditioning system of this embodiment employs the PID control method according to which the residual deviation due to the proportional control is eliminated by the integral control and the deviation of the control value from a target value due to load fluctuations is adjusted by the differential control, whereby high control response is ensured.

(Step S6)

Thereafter, a control signal to the damper driving motor 35 for driving the air mix damper 36 is calculated based on the control value u(t) calculated at Step S5 and the control signal thus calculated is output to the damper driving motor 35. Thereby, the damper position of the air mix damper 36 is controlled. Through the positional control of the air mix damper 36, the ratio between the volume of air passing through the heater core 33 provided in one passage 31 and the volume of air passing through the other passage 32 is adjusted and the temperature of air ejected from each of the air outlets 5, 6, 7, 8 is controlled.

(Step S7)

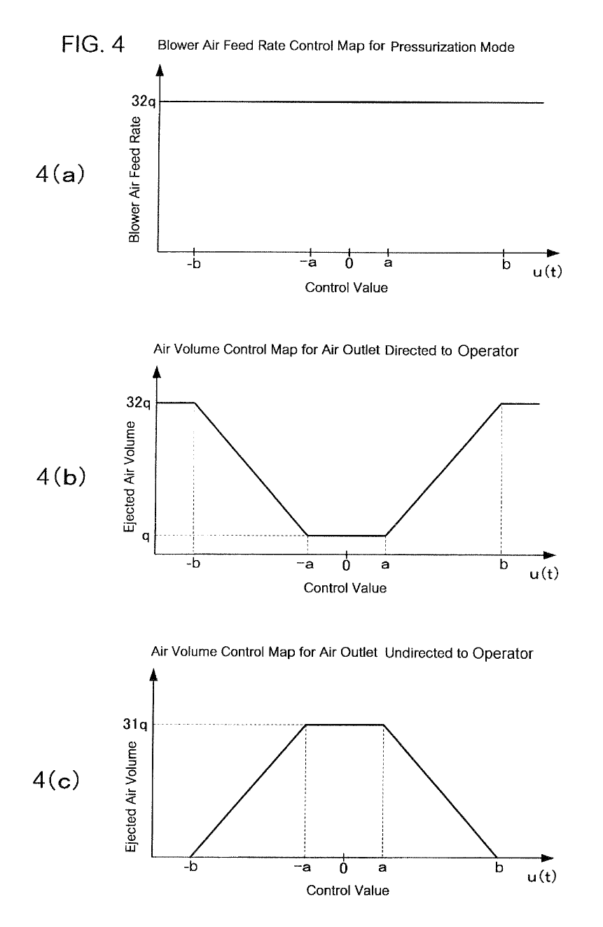

Then, a control signal to the fan driving motor 27 is calculated based on the air feed rate control map shown in FIG. 4(a), and the control signal thus calculated is output to the fan driving motor 27. Thereby, the air feed rate of the blower 11 is set to a constant rate 32q regardless of the control value u(t). In other words, the air feed rate is constant irrespective of the difference between the preset temperature and the inside air temperature, as far as other conditions are not changed. With this air feed rate, the inside pressure of the operator's cab is maintained at values 50 to 200 Pa higher than the pressure outside the operator's cab.

(Step S8)

Then, the volume of air to be ejected from all of the face-level air outlet 5, the rear air outlet 6 and the foot-level air outlet 7 or the volume of air to be ejected from selected one or more of these air outlets 5, 6, 7 is determined based on the air volume control map for the air outlets directed to the operator shown in FIG. 4(b). The volume of air to be ejected from the defroster air outlet 8 is determined based on the air volume control map for the air outlet undirected to the operator shown in FIG. 4(c). Thereby, the distribution of air from the blower 11 is determined (the feed rate of air=32q).

For instance, if the control value u(t) calculated at Step S5 satisfies u(t)≦−b and u(t)≧b, all the air from the blower 11 is ejected from the air outlets directed to the operator. If the control value u(t) is described by −b<u(t)≦−a, the volume of air ejected from the air outlets directed to the operator linearly decreases as the control value u(t) increases, whereas the decreased volumes of air are ejected from the air outlets undirected to the operator. If the control value u(t) is described by −a<u(t)<a, the volume of air ejected from the defroster air outlet 8 is determined to be 31q based on the air volume control map shown in FIG. 4(c), and the volume of air ejected from all the face-level air outlet 5, the rear air outlet 6 and the foot-level air outlet 7 or the volume of air ejected from selected one or more of these air outlets 5, 6, 7 is determined to be q based on the air volume control map shown in FIG. 4(b). The sum of the volume of air q and the volume of air 31q is 32q and the volume of air 31q is greater than the volume of air q. If the control value u(t) is described by a≦u(t)<b, the volume of air ejected from the air outlets directed to the operator linearly increases as the control value u(t) increases, so that the air ejected from the air outlet undirected to the operator decreases in amounts corresponding to the increases in the air from the air outlets directed to the operator. For instance, if the preset temperature is 18.0° C., the difference between the inside air temperature and the preset temperature is 0.5° C. where u(t) equals a and 2.0° C. where u(t) equals b.

(Step S9)

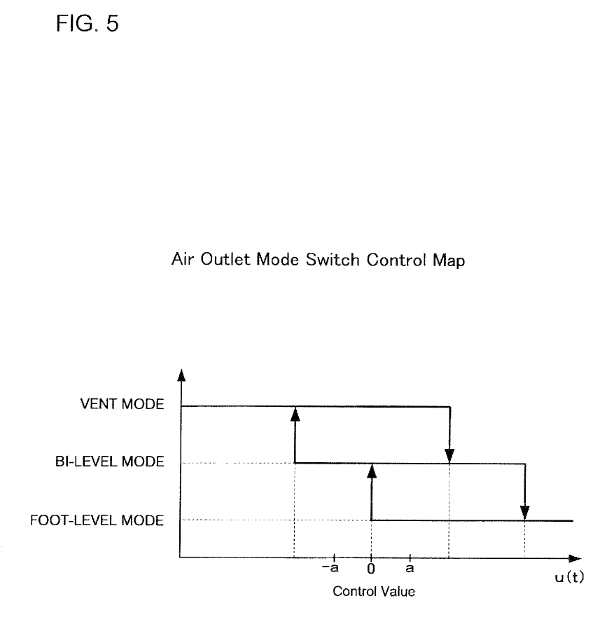

Then, an air outlet mode is set based on the air outlet mode switching control map shown in FIG. 5. In the air outlet mode switching control based on the air outlet mode switching control map, switching between air outlet modes is effected with the control value u(t) to which hysteresis is given, so that occurrence of hunting in switching between air outlet modes can be prevented.

(Step S10)

Control signals to the damper driving motors 51, 52, 53, 54 for driving the first to fourth branch duct opening/closing dampers 41, 42, 43, 44 are calculated based on the distribution of air determined at Step S8 and the air outlet mode determined at Step S9, and the control signals thus calculated are output to the damper driving motors 51, 52, 53, 54. Thereby, the volume of air distributed to all the face-level air outlet 5, the rear air outlet 6 and the foot-level air outlet 7 or distributed to selected one or more of these air outlets 5, 6, 7 and the volume of air distributed to the defroster air outlet 8 are controlled.

Table 2 shows the concept of a change in the open and closed states of each of the first to fourth branch duct opening/closing dampers 41, 42, 43, 44 when PRESSURIZATION mode is thus selected. In Table 2, “open” and “closed” indicate the open and closed states of each of the first to fourth branch duct opening/closing dampers 41, 42, 43, 44 (similarly to Table 1). Symbol “<” accompanied by “open” indicates that the degree of damper opening is increased by selection of PRESSURIZATION mode and symbol “>” accompanied by “closed” indicates that the degree of damper opening is decreased by selection of PRESSURIZATION mode. The degree of damper opening is dependent upon the control value u(t) that is determined by the preset temperature r(t) and the inside air temperature y(t) as discussed earlier. In Table 2, the opening degrees of the branch duct opening/closing dampers 41, 42, 43 for the air outlets directed to the operator in their open state are decreased, and the opening degree of the branch duct opening/closing damper 44 for the air outlet undirected to the operator in its closed state is increased. However, the same effect can be obtained by increasing the opening degree of the damper 44 alone while keeping the opening degrees of the dampers 41, 42, 43 unchanged.

TABLE 2

| | | BRANCH DUCT OPENING/CLOSING DAMPERS | | | |
|---|---|---|---|---|---|
| | | NUMERAL 41 | NUMERAL 42 | NUMERAL 43 | NUMERAL 44 |
| AIR | VENT MODE | OPEN> | OPEN> | CLOSED | CLOSED< |
| OUTLET | BI-LEVEL MODE | OPEN> | OPEN> | OPEN> | CLOSED< |
| MODES | FOOT MODE | CLOSED | CLOSED | OPEN> | CLOSED< |

If it is determined at Step S1 that the A/C automatic control switch 64 is OFF, the A/C manual control for performing air conditioning according to the operation by the operator will be executed (S11). If it is determined at Step S2 that the inside/outside air changing switch 65 has been switched to select INSIDE AIR INTRODUCTION mode, the inside air of the operator's cab 2 will be circulated to execute INSIDE AIR INTRODUCTION mode for the A/C automatic control (S12). If it is determined at Step S3 that the pressurization switch 66 is OFF, the processes of Steps S13 to S18 will be executed.

(Step S13 to Step S15)

At Steps S13 to S15, the same processes as those of Steps S4 to S6 are executed.

(Step S16)

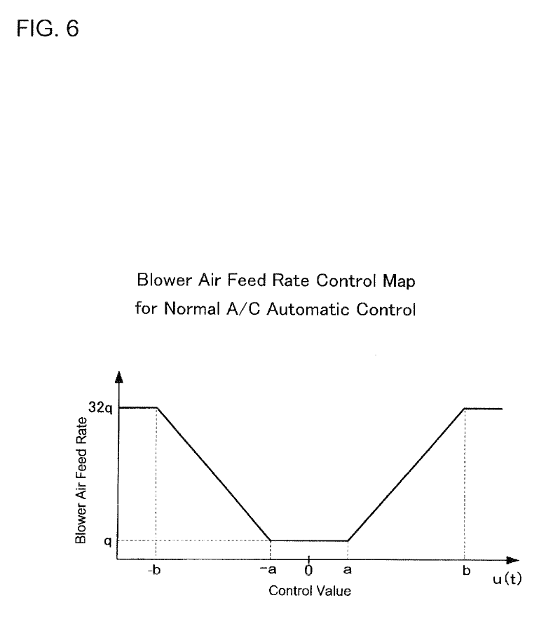

Then, a control signal to the fan driving motor 27 is calculated based on the air volume control map shown in FIG. 6, and the control signal thus calculated is output to the fan driving motor 27. Thereby, the air feed rate of the blower 11 is determined according to the control value u(t).

(Step S17)

Thereafter, an air outlet mode is set based on the air outlet mode switching control map shown in FIG. 5.

(Step S18)

According to the air outlet mode determined at Step S17, control signals to the damper driving motors 51, 52, 53, 54 for driving the first to fourth branch duct opening/closing dampers 41, 42, 43, 44 are calculated, and the control signals thus calculated are output to the damper driving motors 51, 52, 53, 54. Thereby, air is ejected from all the face-level air outlet 5, the rear air outlet 6 and the foot-level air outlet 7 or from selected one or more of these air outlets 5, 6, 7 at the flow rate corresponding to the control value u(t).

In the air conditioning system 1 of the first embodiment, if the A/C automatic control is executed in OUTSIDE AIR INTRODUCING mode and PRESSURIZATION mode is selected by turning ON of the pressurization switch 66, the air feed rate of the blower 11 is then controlled so as to constantly take the value of 32q in compliance with the air volume control map of FIG. 4(a) such that the inside pressure of the operator's cab 2 becomes higher than outside pressure. In this way, the operator's cab 2 is pressurized with the specified volume 32q of air that is required to maintain the inside of the operator's cab 2 at higher pressure than outside pressure. The inside of the operator's cab 2 is accordingly constantly maintained at higher pressure than outside pressure, whereby penetration of dust and so on into the operator's cab 2 can be prevented without fail.

If the difference between the inside air temperature of the operator's cab 2 and the preset temperature becomes small, that is, if the control value u(t) satisfies −a<u(t)<a and VENT mode is selected as the air outlet mode for example, the volume of air to be ejected from the defroster air outlet 8 is determined to be 31q based on the air volume control map of FIG. 4(c) whereas the total volume of air to be ejected from the face-level air outlet 5 and the rear air outlet 6 is determined to be q based on the air volume control map of FIG. 4(b). Then, the third branch duct opening/closing damper 43 is closed while the opening degree of the fourth branch duct opening/closing damper 44 being controlled such that the volume of air blown out from the defroster air outlet 8 becomes 31q. At the same time, the opening degrees of the first branch duct opening/closing damper 41 and the second branch duct opening/closing damper 42 are controlled such that the total volume of air blown out from the face-level air outlet 5 and the rear air outlet 6 becomes q. In this way, the total volume of air ejected from the face-level air outlet 5 and the rear air outlet 6 becomes q which provides comfortable cool or warm feeling to the operator whereas the remaining air (the volume of air=31q) being blown out from the defroster air outlet 8. Accordingly, high pressurization can be carried out without spoiling the comfortable air conditioned environment.

In this embodiment, a temperature control device 67 composed of the evaporator 30, the heater core 33, the air mixing damper 36 and the damper driving motor 35 corresponds to “the temperature controlling means” of the invention. A branch duct opening/closing damper device 68 composed of the branch duct opening/closing dampers 41, 42, 43, 44 and the damper driving motors 51, 52, 53, 54 for the branch duct opening/closing dampers 41, 42, 43, 44 corresponds to “the air distributing means” of the invention. The controller 60 corresponds to “the air feed rate controlling means” and “the air distribution controlling means” of the invention.

### Second Embodiment

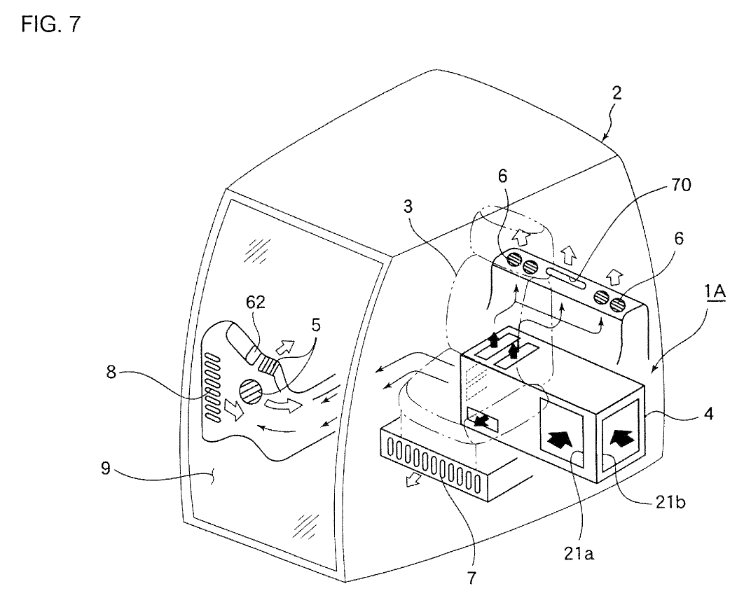

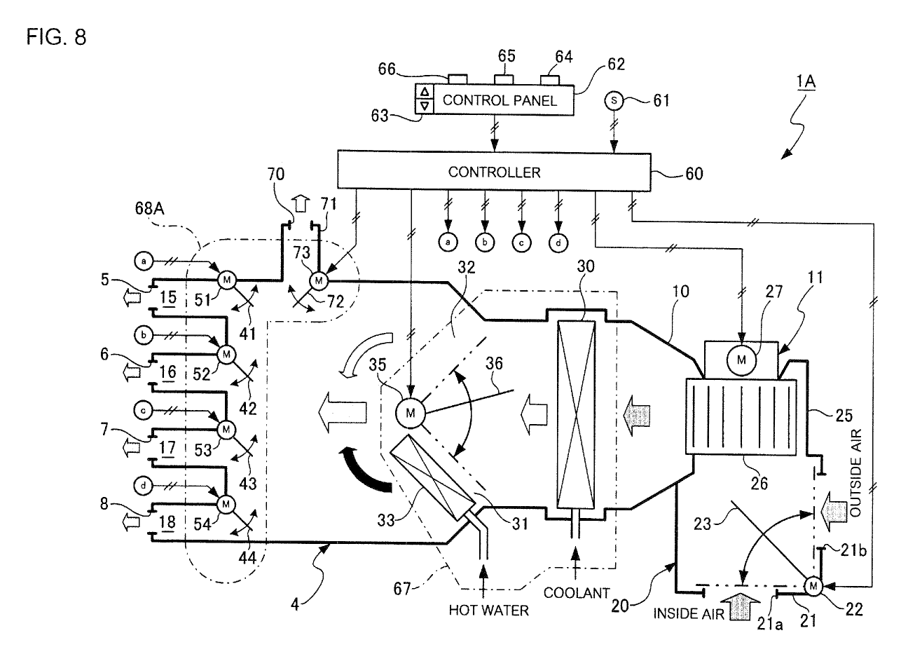

FIG. 7 shows an overall external perspective view of an air conditioning system according to a second embodiment of the invention. FIG. 8 shows a schematic system structural diagram of the air conditioning system 1A of the second embodiment. In the second embodiment, those parts substantially equivalent or similar to the first embodiment are identified by the same reference numerals as in the first embodiment and a detailed explanation thereof is omitted. In the following description, the points different from the first embodiment will be mainly described.

The second embodiment is associated with an example where a dedicated pressurization air outlet (specialized air outlet for operator's cab pressurization) 70 is separately provided which is used exclusively for ejecting air to pressurize the inside of the operator's cab 2 when PRESSURIZATION mode is selected and this dedicated pressurization air outlet 70 assumes the same role as of the defroster air outlet 8 of the first embodiment in PRESSURIZATION mode.

As illustrated in FIG. 7, the dedicated pressurization air outlet 70 is arranged to direct air to the ceiling of the operator's cab 2 so that the air ejected from the air outlet 70 does not directly hit against the operator in the operator's cab 2. The dedicated pressurization air outlet 70 is positioned between the right and left rear air outlets 6 behind the operator's seat 3 that is slightly backwardly shifted from the longitudinal middle position of the operator's cab 2. As illustrated in FIG. 8, the main duct 10 is provided with a fifth branch duct 71 for guiding air to the dedicated pressurization air outlet 70 after the temperature of the air has been adjusted by the temperature control device 67. Provided at the upstream opening of the fifth branch duct 71 is a fifth branch duct opening/closing damper 72 for opening and closing this opening. A damper driving motor 73 for the fifth branch duct opening/closing damper 72 is connected to the controller 60 that issues a control signal to the damper driving motor 73 to control the opening degree of the fifth branch duct opening/closing damper 72. Through the control of the opening degree of the fifth branch duct opening/closing damper 72, the flow rate of air ejected from the dedicated pressurization air outlet 70 is controlled.

In the air conditioning system 1A of the second embodiment, provided that (1) the A/C automatic control is executed in OUTSIDE AIR INTRODUCING mode; (2) PRESSURIZATION mode is selected; (3) −a<u(t)<a; and (4) VENT mode is selected as the air outlet mode, the volume of air to be ejected from the dedicated pressurization air outlet 70 is determined to be 31q based on the air volume control map of FIG. 4(c) whereas the total volume of air to be ejected from the face-level air outlet 5 and the rear air outlet 6 is determined to be q based on the air volume control map of FIG. 4(b). While the third and fourth branch duct opening/closing dampers 43, 44 being respectively closed, the opening degree of the fifth branch duct opening/closing damper 72 is controlled so as to make the volume of air ejected from the dedicated pressurization air outlet 70 be 31q and the opening degrees of the first and second branch duct opening/closing dampers 41, 42 are respectively controlled so as to make the total volume of air ejected from the face-level air outlet 5 and the rear air outlet 6 be q. In this way, the total volume of air ejected from the face-level air outlet 5 and the rear air outlet 6 is made to be q which provides comfortable cool or warm feeling to the operator whereas the remaining air (the volume of air=31q) being ejected from the dedicated pressurization air outlet 70. Accordingly, the second embodiment exhibits the same effect as of the first embodiment.

Whereas the air conditioning system of the invention has been described in accordance with a plurality of embodiments, it is readily apparent that the invention is not necessarily limited to the particular embodiments shown herein and various changes and modifications are made to the disclosed embodiments without departing from the spirit and scope of the invention.

What is claimed is:

1. An air conditioning system comprising: a blower for sending air introduced through an outside air inlet; temperature controlling means for controlling temperature of the air sent from the blower based on a preset temperature; operator's cab air outlets arranged to eject the air temperature-controlled by the temperature controlling means into an operator's cab; air feed rate controlling means for controlling an air feed rate of the blower so as to make inside pressure of the operator's cab higher than outside pressure,
wherein said operator's cab air outlets include an air outlet directed to an operator to eject the air toward the operator in the operator's cab and an air outlet undirected to the operator to eject the air such that the air does not directly hit against the operator,
the air conditioning system further comprising: air distributing means for distributing the air sent from the blower to the air outlet directed to the operator and the air outlet undirected to the operator; and air distribution controlling means for controlling the distribution by the air distributing means such that a volume of air distributed to the air outlet undirected to the operator is larger than a volume of air distributed to the air outlet directed to the operator, when a difference between the inside air temperature of the operator's cab and the preset temperature is small.

2. The air conditioning system according to claim 1, wherein said air feed rate controlling means maintains the air feed rate at a constant value irrespective of the difference between the inside air temperature of the operator's cab and the preset temperature.

3. The air conditioning system according to claim 1, wherein said air outlet undirected to the operator is a defroster air outlet arranged to eject the air sent from the blower toward an operator's cab window pane.

4. The air conditioning system according to claim 1, wherein said air outlet undirected to the operator is a specialized air outlet for operator's cab pressurization that is arranged at a rear position within the operator's cab to eject the air toward a ceiling of the operator's cab.

5. The air conditioning system according to claim 1, further comprising branch ducts for guiding the air to the operator's cab air outlets respectively,
wherein said air distributing means comprises branch duct opening/closing dampers for opening and closing paths of the branch ducts respectively.
